(19) United States
(12) Patent Application Publication
(10) Pub. No.: US 2024/0112173 A1
(43) Pub. Date: Apr. 4, 2024

(54) Remotely Activated Gift Card

(71) Applicant: Plasticard-Locktech International, LLC, North Las Vegas, NV (US)

(72) Inventors: Mary Parks, Las Vegas, NV (US); Stephanie Schneider-Thompson, Las Vegas, NV (US)

(21) Appl. No.: 17/957,629

(22) Filed: Sep. 30, 2022

(51) Int. Cl. G06Q 20/34

(52) U.S. Cl. CPC G06Q 20/354; G06Q 20/342

(57) ABSTRACT

A two-ply remote activation gift card comprises a first and second ply, each such ply having an exterior surface and an opposed interior surface, the interior surfaces of which are in contact with one another, the exterior surface of the first ply having a media area and corresponding non-peelable adhesive material, the exterior surface of the first ply further having a gift area and a corresponding peelable adhesive, and the second ply being divided into two portions by a perforation where one of those two portions is a media portion and the other portion is a non-monetized gift card.

### BACKGROUND OF THE INVENTION

### 1. Field of the Invention

The present invention relates to a flexible, two-ply strip where the first (or bottom) ply is adapted to adhere to and seal closed a bag, box or other container and the second (or top) ply includes a non-monetized gift card that can be peeled off of the first ply and remotely monetized and activated.

### 2. Description of the Related Art

The related art may include two-ply strips, gift cards, and adhesive strips.

Keckeisen et al. (U.S. Pat. No. 7,608,317) discloses printing on an outer (exterior) surface of a multilayer film where one of the film layers comprises a coupon or game piece and the printing may comprise an entitlement such as a cash refund.

Hagen (U.S. Pat. No. 5,855,434) discloses a package reclosure label which is secured by a pressure sensitive adhesive to the package which may include a coupon.

Knoerzer et al. (U.S. Pat. No. 7,686,513) discloses a flexible container with a wall structure comprising a multi-layer, flexible thin film and a removable portion that may be used as a coupon or as a means to permit closure of the bag.

Pedrini (U.S. Pat. No. 5,582,889) discloses a self-adhesive label including a first layer having a permanently self-adhesive side stuck to a packet, and a second layer, having a removable self-adhesive side intended to be stuck to the first layer.

Traineau (FR 2,878,234 B1) discloses a self-adhesive strip utilized to re-close a package once its top has been folded or rolled following first opening. The self-adhesive strip has a back layer that adheres to the package, and a front layer that is attached to the back layer and can be partially detached from it to adhere to the package and hold down the folded or rolled top.

None of this prior art discloses a flexible, two-ply strip where the outer, exterior surface of the first or bottom ply is adapted to keep a package closed and the outer, exterior surface of the second or top ply comprises an unmonetized, remotely monetizable gift card that can be peeled off of the first ply and given as a gift.

### SUMMARY OF THE INVENTION

The invention is a flexible, two-ply strip where the first ply has an adhesive to keep a bag or other container closed and the second ply comprises a peel-off gift card portion and a media portion. The peel-off gift card portion bears unique barcode data or other unique identification means for remotely loading any monetary value onto the gift card and remotely activating it. The media portion is not peelable and typically bears advertising, branding material and/or instructions.

The first ply of the two-ply strip can be used to seal bags for restaurant take-out or delivery, to close clamshell packages typically used for holding packaged to-go salads and sandwiches, or to apply to any other bag, package, container, box, drink lid or product.

The two-ply strip is dispensed from a roll of two-ply strips where each two-ply strip is attached to an adjacent two-ply strip by a perforation or slit that allows each two-ply strip to be torn off the roll.

The first or bottom ply has opposed interior and exterior surfaces. The exterior surface of the first ply typically has an adhesive that allows the first ply to seal a bag or container or otherwise stick to a solid object. The peelable gift card portion of the second or top ply has opposed interior and exterior surfaces. The media portion of the second or top ply has opposed interior and exterior surfaces. The interior surface of the peelable gift card portion and the interior surface of the media portion are collectively coextensive with, and face, the interior surface of the first or bottom ply.

The interior surface of the peelable gift card portion and the corresponding portion of the interior surface of the first ply are adapted to remain in peelable contact with one another until the peelable gift card portion is peeled away. This peelable contact between the interior surface of the peelable gift card portion and the corresponding portion of the interior surface of the first ply is accomplished by using a peelable or removable adhesive applied to the interior surface of the peelable gift card portion and/or to the corresponding portion of the interior surface of the first ply. This peelable or removable adhesive is a light or clean-release adhesive that may be in the form of a coating, film or layer.

The interior surface of the media portion and the corresponding portion of the interior surface of the first ply are adapted to remain in non-peelable contact with one another. This non-peelable contact between the interior surface of the media portion and the corresponding portion of the interior surface of the first ply is accomplished by using a non-peelable or permanent adhesive applied to the interior surface of the media portion and/or to the corresponding portion of the interior surface of the first ply.

The exterior surface of the first ply may be peelably attached to a backing paper or release liner. This backing paper has a release surface and an exterior surface opposite thereto. This peelable attachment between the release surface and the exterior surface of the first ply is accomplished by using a peelable or removable adhesive applied to the release surface and/or to the exterior surface of the first ply. The perforations that separate each two-ply strip from an adjacent two-ply strip may also extend through and perforate the backing paper.

In addition to the perforations through both plies that attach each two-ply strip to an adjacent two-ply strip and that may extend through the backing paper, the top ply of each two-ply strip has an additional micro perforation or slit that exists only in the top ply. This micro perforation or slit divides the second ply into two portions—a peelable gift card portion and a non-peelable media portion. Each peelable gift card portion bears a human-readable, unique numeric or alpha-numeric character that identifies that particular gift card for purposes of activating it with any dollar amount selected by the end user, a.k.a. receiving customer. Each gift card may also bear a barcode, a QR code, and/or a PIN number underneath scratch-off material. Each activated gift card can be redeemed only at the restaurant or business that issued the gift card or at any participating locations affiliated with the original issuer, such as with a chain restaurant or retailer.

Rolls of the two-ply strip of remote activation gift cards are sold or provided to retail businesses and to third-party processors. Third-party processors, in turn, sell the rolls of two-ply strips of remote activation gift cards to their respective customers.

The gift card has no dollar amount when it is applied by a restaurant or other business to a bag, container or product. The end user or receiving customer who receives a non-monetized gift card can activate it with any dollar amount, subject to the retailer's maximum limit per card, by using the gift card's pre-printed indicia and a smartphone or by going to the website of the entity that will activate it. Activation is typically done via a third-party processor. This activation can also be done remotely via certain retailers' internal process or via an 800 or other toll-free number using a credit card, PayPal, etc. Activation may also be available in person at certain businesses.

When the end user activates the gift card on a website, the end user may also be given the option to activate, or be automatically supplied with, an electronic version of the gift card. This electronic gift card can be redeemed either by printing out a copy and taking it to the restaurant or other business that issued it or, if ordering food or items online, by inputting its code into a promotional/code section when paying for the online order. The gift card can also be effectively transferred or given to someone by an email or text message that discloses the gift card's unique code.

### BRIEF DESCRIPTION OF THE DRAWINGS

By way of example only, selected embodiments and aspects of the present invention are described below. Each such description refers to a particular figure (“FIG.”) which shows the described matter. All such figures are shown in drawings that accompany this specification. Each such figure includes one or more reference characters that identify one or more part(s), element(s) or component(s) of the invention.

FIG. 1 shows a restaurant take-out bag bearing a two-ply, remote activation gift card where the first ply is adhered to the bag and the second ply is divided into a gift card portion and a media/graphics/branding/instruction portion.

FIG. 2 shows a roll of two-ply, remote activation gift cards where a two-ply remote activation gift card is at the open end of the roll and is in position to be torn off the roll.

FIG. 3 shows a top view of a two-ply, remote activation gift card.

FIG. 4 shows a side view of the two-ply, remote activation gift card shown in FIG. 3 where the thickness of each ply is disproportionately magnified compared to its length.

### DESCRIPTION OF PREFERRED EMBODIMENT

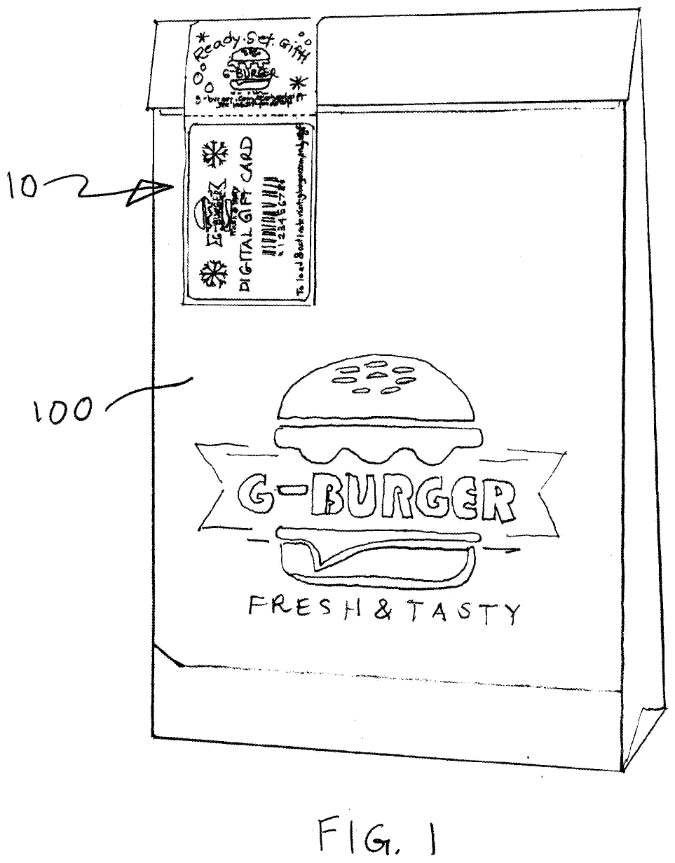

The invention will now be described with reference to the embodiment shown in FIGS. 1 through 4.

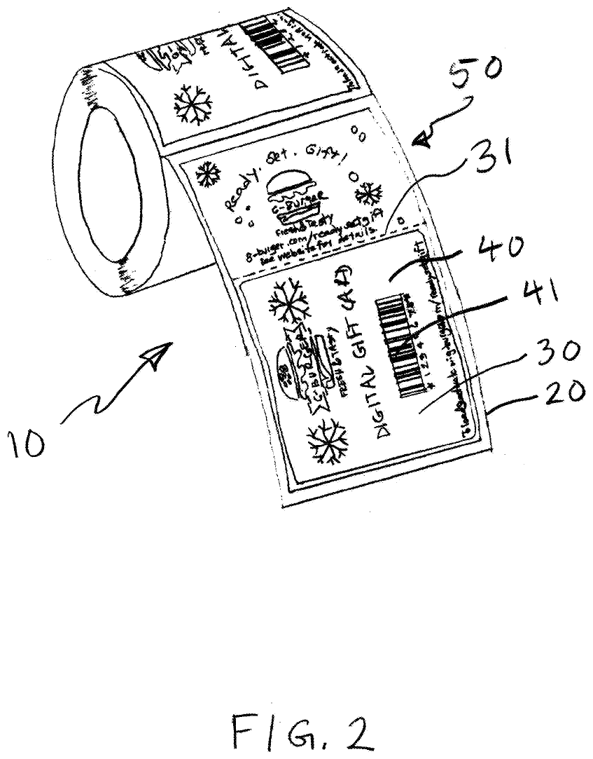

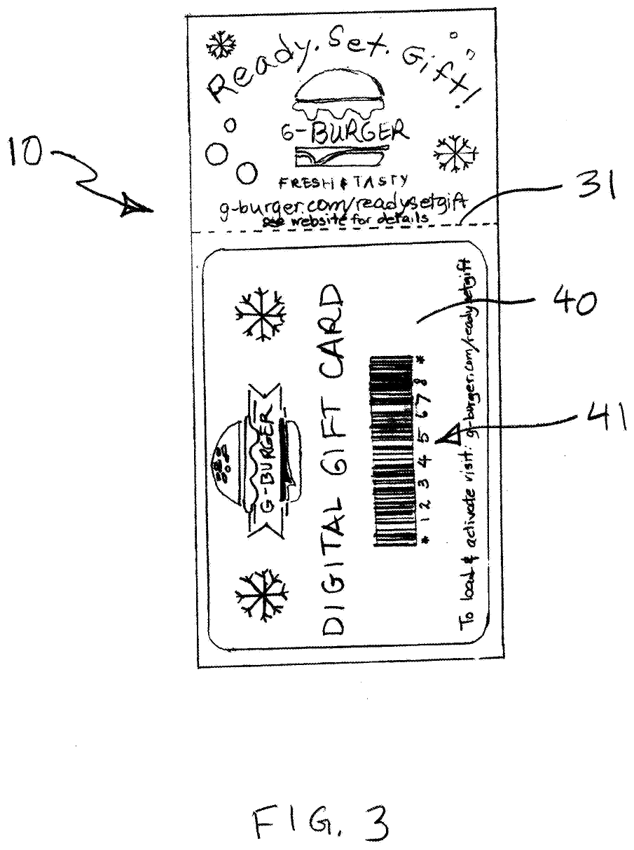

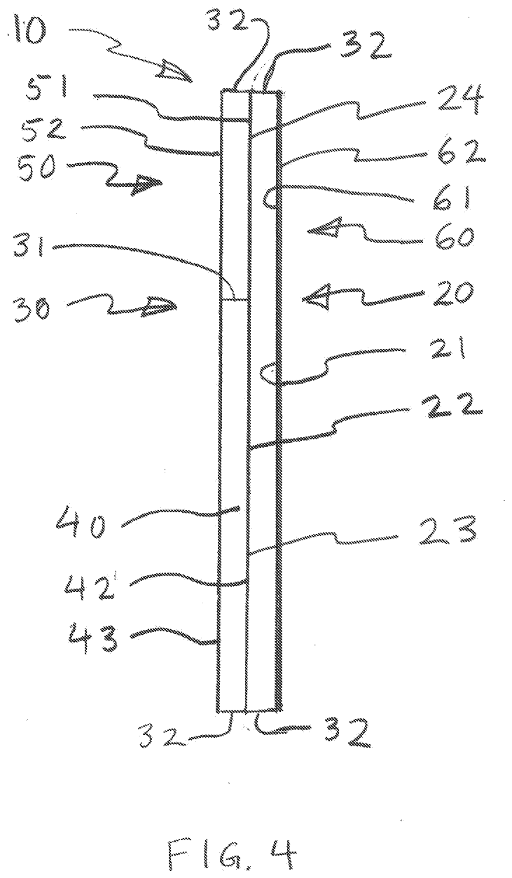

As shown in FIG. 1, in one embodiment of the instant invention, a two-ply, remote activation gift card 10 is affixed to the otherwise open end of a restaurant take-out bag 100. As shown in FIGS. 2 and 3, the two-ply, remote activation gift card 10 comprises a first or bottom ply 20 and a second or top ply 30 coextensive with the bottom ply 20. The top ply 30 further comprises a micro perforation 31 that extends across the entire width of the top ply 30 and divides the top ply 30 into two portions, the first portion of which is a peelable gift card portion 40 and the second portion of which is a customizable media portion 50. Each bottom ply 20 and top ply 30 is separated by a perforation 32 from each adjoining bottom ply 20 and top ply 30. As shown in FIG. 4, the remote activation gift card 10 may further comprise a backing paper 60.

The peelable gift card portion 40 bears a unique identifier 41 that is used to monetize the particular peelable gift card 40 on which it is applied. This unique identifier 41 may be a human readable numeric or alpha-numeric character or a machine-readable barcode or QR code. The unique identifier 41 may also be a personal identification number or other unique identifier that is obscured from view by a coating of scratch-off material. The peelable gift card 40 may also bear instructions and a website address for monetizing and activating the peelable gift card 40.

Ply Surfaces

As shown in FIG. 4, the peelable gift card 40 has a first (or interior) surface 42 and an opposing second (or exterior) surface 43. The unique identifier 41 resides in and/or on the exterior surface 43 of the peelable gift card 40. The interior surface 42 of the peelable gift card 40 does not bear any adhesive and is tacky free.

The media portion 50 has a first (or interior) surface 51 and an opposing second (or exterior) surface 52. The interior surface 51 of the media portion 50 may bear a non-peelable adhesive. The exterior surface 52 of the media portion 50 typically bears graphics, branding material, and/or instructions for monetizing and activating the gift card 40 and/or other information, advertising, marketing or promotional material.

The bottom ply 20 has a first (or exterior) surface 21 and an opposing second (or interior) surface 22. The exterior surface 21 has an adhesive that allows the two-ply, remote activation gift card 10 to be affixed to a bag, box, container or other object.

The portion of the interior surface 22 of the bottom ply 20 that corresponds to, faces and is coextensive with, the interior surface 42 of the peelable gift card 40, is also known as the gift area 23 of the interior surface 22. This gift area 23 of the interior surface 22 is in peelable contact with the interior surface 42 of the peelable gift card 40. This peelability is achieved by the use of a light or clean-release adhesive or other treatment or coating on the gift area 23, or on the interior surface 42 of the peelable gift card 40, or on both the gift area 23 and the interior surface 42.

The portion of the interior surface 22 of the bottom ply 20 that corresponds to, faces and is coextensive with, the interior surface 51 of the media portion 50, is also known as the media area 24 of the interior surface 22. This media area 24 of the interior surface 22 is in non-peelable contact with the interior surface 51 of the media portion 50. This non-peelability is carried out by the use of permanent adhesive on the media area 24, or permanent adhesive on the interior surface 51, or permanent adhesive on both the media area 24 and the interior surface 51.

The backing paper 60 has a release surface 61 and an opposing exterior surface 62. The release surface 61 faces and is coextensive with the exterior surface 21 of the bottom ply 20. The backing paper 60 is in releasable contact with the exterior surface 21. This releasability is carried out by the use of a light or clean-release adhesive on the release surface 61, or a light or clean-release adhesive on the exterior surface 21, or a light or clean-release adhesive on both the release surface 61 and the exterior surface 21. The backing paper 60 may further comprise perforations 32.

Monetization and Activation

The receiving customer (end user) monetizes and activates the peelable gift card 40 by following instructions printed on the peelable gift card 40 and/or the media portion 50 or by going to a website or webpage, the internet address for which is printed on the peelable gift card 40 and/or the media portion 50. The receiving customer would then specify the monetary amount to be applied to the peelable gift card 40 either in person at the retail business that issued the peelable gift card 40, via telephone call with the retail business or third-party processor, or via website or webpage. Once the retail business or third-party processor confirms that it has received the funds for the monetized amount specified for the peelable gift card 40, the end user will be allowed to activate the peelable gift card 40 at their discretion.

The end user may peel the peelable gift card 40 off of the bottom ply 20 so that the peelable gift card 40 may be given to anyone as a gift. Alternatively, the end user may send or provide an electronic version of the peelable gift card 40 to anyone by email, text, link or other electronic means. Any such electronic transfer of the peelable gift card 40 may be done electronically by transferring an image of the peelable gift card 40 with its attendant unique identifier code displayed on the peelable gift card 40 or by transferring only the human-readable numeric or alpha-numeric code that is unique to the peelable gift card 40.

Distribution

Rolls of two-ply remote activation gift cards 10 are manufactured according to the specifications of the retail business identified on the peelable gift card 40 or according to the specifications of a third-party processor that will supply the rolls of two-ply remote activation gift cards 10 to its business customers. Each business then uses the two-ply remote activation gift cards 10 in any manner it chooses. In the restaurant business, the restaurant would typically affix a two-ply remote activation gift card 10 to any bag, box, lidded drink or container used for takeout orders. Any business that sells its goods online could affix a two-ply remote activation gift card 10 to any bag or box in which the items it sells online are shipped.

Rolls of two-ply remote activation gift cards 10 may be made using known methods and technologies in the manufacture of labels.

The invention disclosed herein is not limited to the specific embodiments described herein. The disclosed embodiments may be modified or have elements deleted or added while still remaining within the scope of this invention. The invention is described herein by way of example only and is not limited to the disclosed example(s) or embodiment(s). Similarly, the figures are provided as examples of the invention and to aid in understanding the invention and not to act as a limitation on the scope of the invention. Each limitation is expressly defined as not being limited to what is shown in the figures. The embodiments disclosed herein may be modified by those skilled in the art without departing from the scope of the invention.

While the foregoing detailed description sets forth a number of embodiments of a remotely activatable gift card in accordance with the present invention, the above description is illustrative only and not limiting of the disclosed invention.

What is claimed is:

1. A remotely activatable gift card comprising:
s a two-ply strip comprising a first ply and a second ply,
the first ply having a first exterior surface and an opposing first interior surface, the first exterior surface bearing an adhesive and the first interior surface comprising a gift area and a media area,
the second ply having a second exterior surface and an opposing second interior surface,
the second ply further having a micro perforation that exists only in the second ply and divides the second ply into a peelable gift card portion and a non peelable media portion, the peelable gift card portion is coextensive with the gift area of the first interior surface and the non-peelable media portion is coextensive with the media area of the first interior surface,
the peelable gift card portion of the second interior surface and the gift area of the first interior surface are adapted to be peeled apart from one another,
the non-peelable media portion of the second interior surface and the media area of the first interior surface are adapted to not be peeled apart from one another,
the peelable gift card portion comprising a unique identifier for use in monetizing and activating the peelable gift card,
wherein the two-ply strip is dispensed from a roll of two-ply strips where each two-ply strip is attached to an adjacent two-ply strip by a perforation that extends through both the first ply and the second ply thereby allowing each two-ply strip to be torn off the roll and affixed to a container.

2. The remotely activatable gift card of claim 1 having a backing paper releasably adhered to the first exterior surface.

3. A method for monetizing and activating a gift card where the gift card is part of a two-ply strip comprising a first ply and a second ply,
the second ply comprises the gift card,
the gift card is peelable from the first ply,
the gift card bears a unique identifier by which the gift card can be monetized and activated,
the first ply has a first exterior surface adapted to be affixed to a container,
and the method for monetizing and activating the gift card comprises the steps of:
entering the unique identifier into a dedicated location on a website,
transferring the desired amount of funds for which the gift card will be monetized, and
receiving confirmation that the gift card has been monetized.

4. A method for monetizing and activating a gift card where the gift card is part of a two-ply strip comprising a first ply and a second ply,
the first ply has a first exterior surface and an opposing first interior surface, the first exterior surface bears an adhesive and the first interior surface comprises a gift area and a media area,
the second ply has a second exterior surface and an opposing second interior surface,
the second ply further has a micro perforation that exists only in the second ply and divides the second ply into a peelable gift card portion and a non-peelable media portion, the peelable gift card portion is coextensive with the gift area of the first interior surface and the non-peelable media portion is coextensive with the media area of the first interior surface,
the peelable gift card portion of the second interior surface and the gift area of the first interior surface are adapted to be peeled apart from one another,
the non-peelable media portion of the second interior surface and the media area of the first interior surface are adapted to not be peeled apart from one another,
the peelable gift card portion comprises a unique identifier for use in monetizing and activating the peelable gift card,
wherein the two-ply strip is dispensed from a roll of two-ply strips where each two-ply strip is attached to an adjacent two-ply strip by a perforation that extends through both the first ply and the second ply thereby allowing each two-ply strip to be torn off the roll and affixed to a container,
and the method for monetizing and activating the gift card comprises the steps of:
entering the unique identifier into a dedicated location on a website,
transferring the desired amount of funds for which the gift card will be monetized, and
receiving confirmation that the gift card has been monetized.
